(19) United States
(12) Patent Application Publication
(10) Pub. No.: US 2004/0232259 A1
(43) Pub. Date: Nov. 25, 2004

(54) Fuel injector with compensation element for fuel-injection systems

(76) Inventor: Dieter Kienzler, Leonberg (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/433,784

(22) PCT Filed: Oct. 7, 2002
(86) PCT No.: PCT/DE02/03756

(30) Foreign Application Priority Data
Oct. 8, 2001 (DE) 101 49 514.5

(51) Int. Cl. F02M 59/00

(52) U.S. Cl. 239/533.2

(57) ABSTRACT

The invention relates to a A fuel injector for injecting fuel into the combustion chamber of an internal combustion engine includes an injector body in which a nozzle needle is movably received, and a nozzle body, which is connected to the injector body at a threaded connection by means of a nozzle lock nut. Associated with a contact face of components to be braced against the injector body by the nozzle lock nut is a deformable compensation element, which compensates for production-dictated oblique positions of the components.

### FIELD OF THE INVENTION

Fuel injectors are used in fuel injection systems that supply fuel, which is at high pressure, to internal combustion engines. As a rule, the fuel injectors include an injector body, a nozzle needle vertically movable in the injector body, a nozzle body, and a nozzle lock nut with which the nozzle body and the injector body are joined together. After the components are installed in the injector body, the injector body is joined to the nozzle lock nut and to the nozzle body received in it. Because of differences in flatness between the face end of the injector body, the nozzle body, and the nozzle lock nut, different pressures per unit of surface area can arise between the injector body and the nozzle lock nut, which when the fuel injector is subjected to fuel that is at high pressure, in high-pressure injection systems such as common rail systems, can lead to leaks.

### PRIOR ART

German Patent Disclosure DE 196 19 523 A1 relates to a fuel injection valve for high-pressure injection. With this fuel injection valve, fuel is injected into the combustion chambers, in particular of self-igniting internal combustion engines. A magnet valve is provided, by which the communication of the fuel injection valve with a high-pressure fuel source is controlled at least indirectly by means of an electrical controller. The electrical controller includes a control circuit, which is subdivided into a first, common circuit part that controls a plurality of fuel injection valves, and second circuit parts; the second circuit parts are each assigned to one fuel injection valve and serve to control the delivery of current to the electromagnet of the magnet valve.

German Patent DE 37 00 687 C2 relates to a fuel injection system for an internal combustion engine. The internal combustion engine is in particular a Diesel engine, with electrically actuated injection elements for each cylinder and with a common rail, preceding the injection elements, that is acted upon as a function of engine rpm and load by means of a continuously pumping fuel pump. The common rail communicates permanently with a conduit in each injection element via an annular chamber and a throttle, and each injection element has a magnet valve that is actuatable for each injection event. Upon its actuation, this magnet valve connects the conduit with a fuel return line, as a result of which a nozzle needle that closes the injection opening is relieved and enables the outflow of fuel from a first pressure chamber directly preceding one of the injection openings. The first pressure chamber communicates, via a line whose length is adapted to the ignition lag time, with a second pressure chamber, associated with the applicable injection element and located in the region thereof, and by way of this latter pressure chamber it communicates with the common rail.

German Patent Disclosure DE 195 46 361 A1 relates to an electromagnetic fuel injection valve and to a method for assembling a nozzle assembly. An electromagnetic fuel injection valve is provided which permits adjusting and setting the length of the stroke once the nozzle assembly has been put together. As a result, it is suitable for use for high-pressure cylinder injection of fuel, and the stroke length can be preset with great precision. A thin-walled socket part is proposed, which is formed on the nozzle holder. A valve seat is introduced under pressure into the socket part; the valve seat and the nozzle holder are welded to the socket part, and an irreversible deformation of the nozzle holder, in order finally to fix the stroke length, is accomplished, preferably by application of a load from outside the nozzle holder, which follows the welding.

German Patent Disclosure DE 196 50 865 A1 relates to a magnet valve. The magnet valve serves to control an injection valve of a fuel injection system having a valve needle whose opening and closing is controlled by a magnet valve. The magnet valve includes an electromagnet and an armature as well as a valve member that moves with the armature and is urged in the closing direction by a valve spring. This valve member cooperates with a valve seat; the armature is embodied in two parts, with a first armature part which is displaceable relative to a second armature part, counter to the force of a restoring spring, in the closing direction of the valve member under the influence of its inertial mass. Part of a hydraulic damping device is provided on the first armature part, and with it after-vibration of the first armature part upon its dynamic displacement can be damped.

German Patent Disclosure DE 195 44 987 A1 has a fuel injection apparatus as its subject. The fuel injection apparatus includes a housing which has a sliding hole in whose axial direction a fuel conduit for introducing fuel into the housing is provided. An injection opening is provided on an end portion of the sliding hole, for injecting the fuel delivered by the fuel conduit. A control pressure chamber is also provided, which on the other end portion of the sliding hole serves to store the fuel delivered by the fuel conduit. A needle valve is movably received in the sliding hole and on one end includes a valve body, which opens the injection opening by means of the fuel delivered to the injection opening by the fuel conduit, and on its other end has a piston; the fuel stored in the control pressure chamber exerts a pressure on the piston in order to force the needle valve in the valve closing direction. A first prestressing device is provided in order to move the needle valve in the valve closing direction. A valve assembly is also provided for interrupting the communication between the fuel conduit and the control pressure chamber, so as to seal off the fuel in this control pressure chamber. A volumetric-change device detects the expansion in volume of the control pressure chamber.

### SUMMARY OF THE INVENTION

The advantages attainable with the provisions according to the invention are above all that with the compensation element, even large angular errors between the nozzle body and the injector body occurring in their assembly can be compensated for. Unfavorable ratios of tolerances of components relative to one another can thus be compensated for, so that even if components involving major deviations are installed, a functional fuel injector can be attained which is fuel-tight at the high pressures that occur in high-pressure injection systems.

If the nozzle body is braced on the deformable compensation element which is let into a cup-shaped nozzle lock nut, then an exact butt joint is established between the face end of the injector body and the face end of the nozzle body once the nozzle lock nut and the nozzle body let into it are screwed to the injector body. Differences in flatness of the face ends of the components to be joined together are compensated for by the deformation of the compensation element. Advantageously, rotation of the compensation element can be avoided by embodying the compensation element with different coefficients of friction on its two sides. The coefficients of friction are such that the coefficient of friction between the nozzle body and the side toward the nozzle body of the compensation element is higher than the coefficient of friction between the nozzle lock nut and the compensation element. It is thus attained that upon tightening of the nozzle lock nut, the compensation element will not rotate with it, or in other words remains fixed in its rotational position relative to the nozzle body.

The compensation element is preferably made from soft metal material. It can be embodied as disklike or annular; on the side of the compensation element pointing toward the nozzle body, there is a higher coefficient of friction than on the side of the compensation element which faces the bottom of the nozzle lock nut. Upon assembly of the fuel injector, the compensation element can be received in a chamber inside which it is deformable. The expansion of the chamber determines the limit of deformation of the deformable compensation element.

On the other hand, before the final tightening of the nozzle lock nut, the deformable compensation element can rest on annularly extending contact faces of the components of the fuel injector that are to be joined together. If the compensation element is surrounded by a chamber, then upon final tightening of the nozzle lock nut, the deformation of the compensation element is limited by the minimum volume of this chamber.

The compensation element can also be used in fuel injectors that besides the components comprising the injector body, nozzle body and nozzle lock nut also include annular insert parts, such as a valve part and shims. If these components are fixed in their rotary position to one another by a rotary position securing means, such as an alignment pin, then compensation elements at which different coefficients of friction on the two faces are not necessary can be used.

With the proposed provisions, tolerance-dictated oblique positions of contact faces, caused by angular errors of the injector body, nozzle lock nut and nozzle body, and possibly still other components provided, can be compensated for, making it possible to avoid different pressures per unit of surface area; that is, the fuel injector is sealed off in the axial direction per se as a result of a uniform course of the contact pressure of its components.

Still another advantageous effect of the proposed invention is that injector components which because of their individual production tolerances do not meet the quality demands made of them can still be joined to a fuel injector. Thus the production rate of usable components can be increased considerably.

### DRAWING

The invention will be described in further detail below in conjunction with the drawing.

Shown are:

FIG. 1, a current fuel injector known from the prior art;

FIG. 2, a compensation element between the nozzle body and the nozzle lock nut, with a rectangular material cross section;

FIG. 3, a compensation element of cylindrical cross section in the undeformed state, in a chamber between the nozzle body and the nozzle lock nut;

FIG. 4, the configuration of FIG. 3, in a state braced against one another; and

FIG. 5, a fuel injector with a valve part and a shim, between which a compensation element can also be installed.

### VARIANT EMBODIMENTS

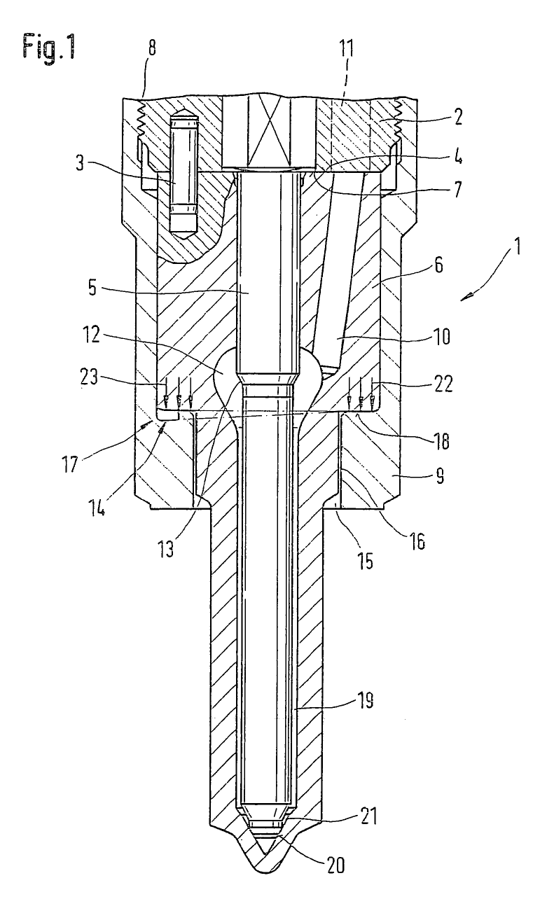

FIG. 1 shows one embodiment of a fuel injector in the prior art.

The fuel injector 1 as shown in FIG. 1 includes an injector body 2. By means of an alignment pin 3, the injector body 2 and a nozzle body 6 are fixed in their rotary position to one another and aligned. The injector body 2 rests with its face end 4 on a face end 7 of the nozzle body 6. Both the injector body 2 and the nozzle body 6 are penetrated by a nozzle needle 5, which in the fuel injector 1 of FIG. 1 can move up and down in the vertical direction.

The nozzle body 6 of the fuel injector 1 is enclosed by a nozzle lock nut 9 of cup-shaped configuration. In its upper region, the nozzle lock nut 9 has a female thread, which is joined by a male thread to the lower region of the injector body 2 at a threaded connection 8 when the injector body 2 and the nozzle body 6 are screwed together by means of the nozzle lock nut 9. A nozzle chamber 12 is embodied in the nozzle body 6, and an inlet bore 10 discharges into it and in turn communicates with an inlet bore 11 in the injector body 2 and introduces fuel that is at high pressure into the nozzle chamber 12. In the region of the nozzle chamber 12 in the nozzle body 6, the nozzle needle 5 that can move up and down in the fuel injector 1 is provided with a pressure shoulder 13.

An angular offset 14 is shown exaggerated in the illustration of FIG. 1; it is due to deviations in flatness of the nozzle lock nut 9 and of the nozzle body 6 resting in it on the contact face 18. Because of the angular offset 14 of the pressure shoulder 13 of the nozzle body 6, or of the bottom of the nozzle lock nut 9, a different distribution of pressures per unit of surface area, indicated by reference numerals 22 and 23 in FIG. 1, is established. In the region of the first pressure per unit of surface area 22, sealing of the fuel injector from the outset exists, while in the region of the second pressure per unit of surface area 23, there is a potential leakage site 17, at which fuel can escape along a gap 16 between the tip of the nozzle body 6 and the bore 15 in the nozzle lock nut 9.

For the sake of completeness, it should be noted that the nozzle needle 5 is seated in a needle seat 20 on the end toward the combustion chamber of the nozzle body and can be acted upon from the nozzle chamber 12, via a nozzle needle gap 19, with fuel that is at high pressure, which when the nozzle needle 5 is open discharges via an inlet gap, marked by reference numeral 21, at the injection openings into the combustion chamber of the engine.

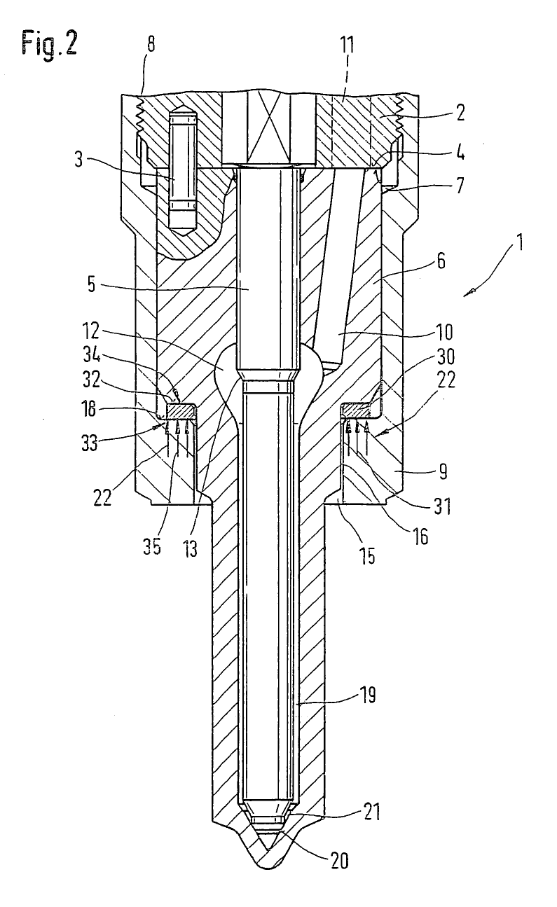

FIG. 2 shows a compensation element between the nozzle body and the nozzle lock nut whose material cross section is rectangular in nature.

Unlike the version of a fuel injector in the prior art shown in FIG. 1, in the variant embodiment of FIG. 2 an angular offset 14 and attendant different pressures 22, 23 per unit of surface area in the region of the contact face 18 between the nozzle body 6 and the nozzle lock nut 9 is precluded by the integration of a deformable compensation element 30. The compensation element 30, as shown in FIG. 2, is in the nature of a disklike inserted element of soft metal material. On a first side 32 of the deformable compensation element 30, the compensation element is in contact with a shoulder on the nozzle body 6. A second side 33 of the deformable compensation element 30, which in FIG. 2 is embodied with a rectangular cross section 31, rests on the bottom face 18 of the nozzle lock nut 9.

To prevent rotation of the deformable compensation element 30 upon tightening of the nozzle lock nut 9 onto the injector body 2 of the injector body 1, a first coefficient of friction 34 prevails at the first side 32 of the deformable compensation element 30, while a second coefficient of friction 35 is established on the underside of the deformable compensation element 30, that is, the second side 33. Advantageously, the coefficient of friction 34 on the side of the 30 toward the nozzle body 6 is higher than that on the second side 33 of the deformable compensation element 30, that is, than the coefficient of friction 35. When the nozzle lock nut 9 is tightened with the prescribed assembly torque, the higher coefficient of friction 34 on the first side 32 prevents the deformable compensation element 30 from rotating with the lock nut in the direction of rotation of the nozzle lock nut 9. Because of the higher coefficient of friction 34 between the pressure shoulder 13 of the nozzle body 6 and the first side 32 of the deformable compensation element 30, the deformable compensation element 30—in this case in disk form—rests in stationary fashion on the nozzle body 6, while the nozzle lock nut 9, rotated by a tool not shown here, can be rotated relative to the second side 33, which has a lower coefficient of friction 35.

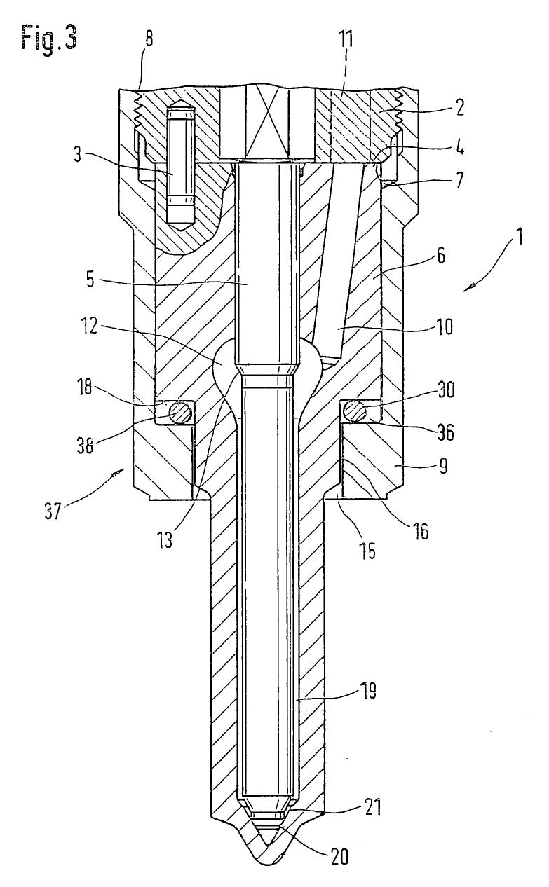

FIG. 3 shows a further variant embodiment of the invention, with a compensation element of cylindrical cross section in the undeformed state in a chamber between the nozzle body and the nozzle lock nut.

As shown in FIG. 3, a deformable compensation element 30, which in this variant embodiment is annular in shape, or in other words has a cylindrical cross section 38, is let into a chamber 36 between a shoulder of the nozzle body 6 and the bearing face 18 on the bottom of the nozzle lock nut 9. In the undeformed state 37 of the deformable compensation element 30, shown in FIG. 3, the compensation element fills up the chamber 36; that is, the shoulder of the nozzle body 6 and the bearing face rest in such a way on the circumferential face of the deformable compensation element 30 that this compensation element is still just barely not yet deformed.

For the sake of completeness, it should be noted that the nozzle body 6, let into the rotatable nozzle lock nut 9, has a vertically movable nozzle needle 5, which in the region of a nozzle chamber 12 embodied in the nozzle body 6 includes a pressure shoulder 13. The nozzle chamber 12 in the interior of the nozzle body 6 is acted upon via an inlet bore 10 by fuel that is at high pressure, and the inlet bore 10 in the nozzle body 6 is supplied with fuel via an inlet bore 11 in the injector body 2. The threaded connection between the nozzle lock nut 9 and the injector body 2 of the fuel injector 1 is identified by reference numeral 8. Rotation of the nozzle body 6 and of the injector body 2 is prevented by an alignment pin 3, so that the face end 4 of the injector body 2 and the face end 7 of the nozzle body 6 are aligned with one another at a butt joint.

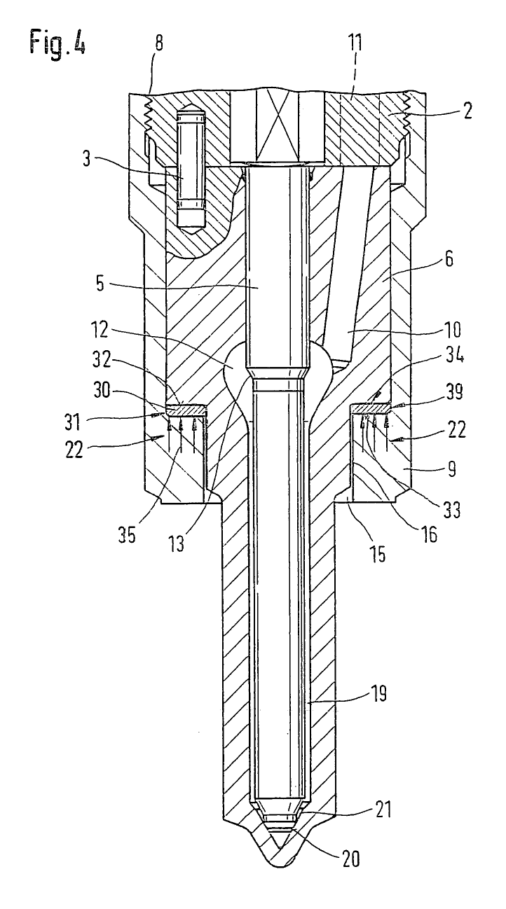

FIG. 4 shows the configuration of FIG. 3 in the state braced against one another.

The braced state of the fuel injector components 2, 6 and 9 is represented by reference numeral 39 in the view in FIG. 4. Once the injector body 2 and the nozzle body 6 have been correctly aligned, torque is introduced into the nozzle lock nut 9, so that the nozzle body 6 and the injector body 2 are screwed together at the threaded connection 8. This causes the pressure shoulder 13 of the nozzle body 6 and the bottom face 18 of the nozzle lock nut 9 to move toward one another.

The deformable compensation element 30 of cylindrical cross section 38 shown in FIG. 3, with further rotation of the nozzle lock nut 9, assumes a rectangular cross section 31; the maximum deformation of the deformable compensation element 30 is defined by the minimum chamber volume of the chamber 36. In the braced state 39, the first face 32 of the deformable compensation element 30 rests flatly on the pressure shoulder 13 of the nozzle body 6, while the second face 33 of the deformable compensation element 30 rests on the bottom face of the nozzle lock nut. As a result of the bracing, errors in angular offset 14 (compare FIG. 1) are compensated for, and a uniform first pressure per unit of surface area 22 extending over the deformable compensation element 30 is established between the nozzle lock nut 9, nozzle body 6, and accordingly the injector body 2. The deformable compensation element 30 that fills the minimum chamber volume of the chamber 36 forms a seal sealing off the gap 16 between the nozzle body 6 and the nozzle lock nut 9, so that besides compensation of differences in flatness between the nozzle lock nut 9 and the shoulder of the nozzle body 6, a uniform pressure per unit of surface area and thus an optimal sealing action between the nozzle body, which is enclosed by the lock nut 9, and the lock nut itself can be attained. An escape of fuel along the gap 16, which represents a potential leakage site, between the tapered portion of the nozzle body 6 and the bore 15 of the nozzle body 6 is thus precluded. Depending on the material used for the deformable compensation element 30, a soft support of the nozzle body 6 in the nozzle lock nut 9 can be achieved.

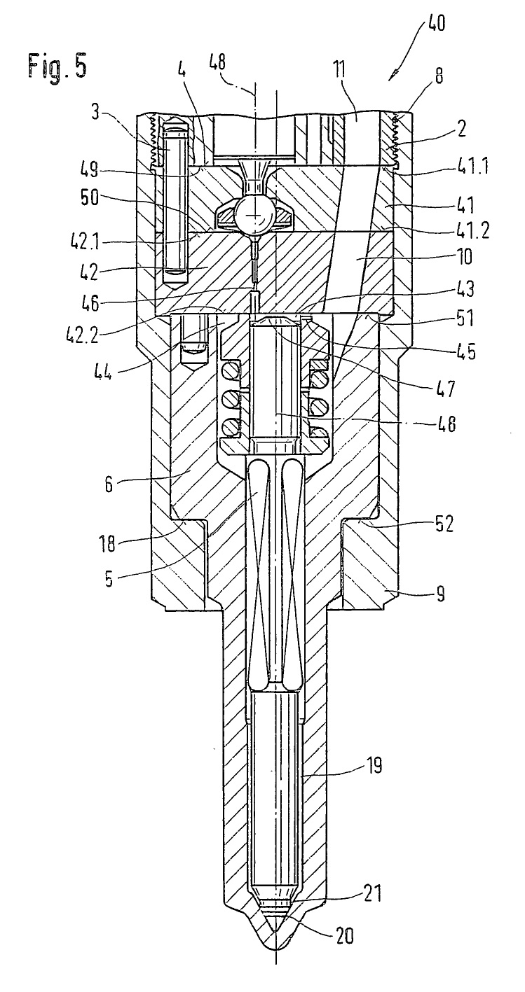

FIG. 5 shows a fuel injector with a valve part and shim, between which the compensation element can also be installed.

The fuel injector 40 shown in FIG. 5 for injecting fuel into the combustion chamber of an internal combustion engine differs from the fuel injectors of FIGS. 2, 3 and 4 in that a separate valve part 41 of annular form and a shim 42 are let in between the injector body 2 and the nozzle body 6. The valve part 41 has a first end face 41.1 and a second end face 41.2. The shim 42, which as shown in FIG. 5 is disposed between the valve part 41 and the nozzle body 6, has a face end 42.1 and further face end 42.2. By means of the alignment pin 3, both the valve part 41 and the shim 42 are fixed in their relative rotary position. Between the lower face end of the injector body 2 and the first face end 41.1 of the valve part 41, a first butt joint 49 is accordingly formed, while a second butt joint 50 is formed by the second face end 41.2 of the valve part 41 and the first face end 42.1 of the shim 42. A further, third butt joint 51 is formed by the second face end 42.2 of the shim 42 and the upper face end of the nozzle body 6. In a distinction from what is shown in FIGS. 2, 3 and 4, the nozzle needle 5, which is disposed symmetrically to the axis of symmetry 48 of the fuel injector 40, includes free flow faces, through which the fuel volume to be injected enters the nozzle needle gap 19 on the tapered end of the nozzle body 6.

The deformable compensation element 30, whether of rectangular cross section 31 or cylindrical cross section 38, can be let in at either the first butt joint 49, or the second butt joint 40, or the third butt joint 51.

The nozzle needle 5, which in the fuel injector 40 is let in symmetrically to the line of symmetry 48, includes an end face 47, which protrudes into a control chamber 43. The control chamber 43 is supplied with fuel, which is at high pressure, via an inlet throttle element 45 from an annular chamber 44. The annular chamber 44 in turn communicates with an inlet conduit 10, which via an inlet bore 11 from the injector body 2 is subjected to fuel, which is at high pressure, from the high-pressure rail or some other high-pressure source. A pressure relief of the control chamber 43 is effected by means of an outlet throttle element 46, which in the view shown in FIG. 5 is embodied in the shim 42. The outlet throttle element 46 is actuated by a closing body, which is supported in the valve part 41 and is movable via an actuating element, not shown, that is embodied for instance as a magnet valve, so that the control chamber can be pressure-relieved for actuating the nozzle needle 5.

With the embodiment proposed according to the invention, tolerance-dictated oblique positions from angular errors at the injector body 2, nozzle lock nut 9, nozzle body 6 and the additional built-in components 41 and 42 can be compensated for by the integration of a deformable compensation element 30. The deformable compensation element 30 can be provided with different coefficients of friction on its first side 32 and its second side 33, and a higher coefficient of friction 34 can be embodied for instance on the side of the deformable compensation element 30 pointing toward a nozzle body 6 than on the second side 33 of the deformable compensation element 30. The integration of a deformable compensation element 30 makes it possible to avoid different contact pressures in the axial direction from an oblique position of the components 2, 6, 9 and possibly 41, 42 to be braced together, so that a uniform pressure per unit of surface area and thus a high degree of tightness of the fuel injector at the sealing face 52 (see FIG. 5) can be established and the efficiency of the fuel injector 1 and 40 can be increased.

### List of Reference Numerals

1 Fuel injector

2 Injector body

3 Alignment pin

4 End face

5 Nozzle needle

6 Nozzle body

7 End face

8 Threaded connection

9 Nozzle lock nut

10 Inlet bore of nozzle body

11 Inlet bore of injector body

12 Nozzle chamber

13 Pressure shoulder

14 Angular offset

15 Bore of nozzle lock nut

16 Gap

17 Potential site of leakage because of oblique position

18 Bearing face

19 Nozzle needle gap

20 Needle seat

21 Inlet gap

22 First pressure per unit of surface area

23 Second pressure per unit of surface area

30 Deformable compensation element

31 Rectangular cross section

32 First face

33 Second face

34 Coefficient of friction on side toward nozzle body

35 Coefficient of friction on side toward nozzle lock nut

36 Chamber

37 Undeformed state

38 Cylindrical cross section

39 Deformed state

40 Fuel injector with valve part and shim

41 Valve part

41.1 First face end

41.2 Second face end

42 Shim

42.1 First face end

42.2 Second face end

43 Control chamber

44 Annular chamber

45 Inlet throttle

46 Outlet throttle

47 End face of nozzle needle

48 Line of symmetry

49 Butt joint of nozzle body and valve part

50 Butt joint of valve part and shim

51 Butt joint of shim and nozzle body

52 Sealing face

1-9. (Cancelled)

10. A fuel injector for injecting fuel into the combustion chamber of an internal combustion engine, comprising
having an injector body (2)
a nozzle needle (5) movably received in the injector body (2)
a nozzle body (6),
a nozzle lock nut (9) threadably connecting the nozzle body (6) to the injector body (2) at a threaded connection (8), and
a deformable compensation element (30) disposed between opposed surfaces associated with contact faces (18; 49, 50, 51, 52) of components (6, 41, 42, 9) to be braced against the injector body (2) by the nozzle lock nut (9), which compensation element (30) compensates for production-dictated oblique positions of the components (6, 41, 42, 9).

11. The fuel injector of claim 10, wherein the deformable compensation element (30) is made from a soft metal material.

12. The fuel injector of claim 10, wherein the deformable compensation element (30) is embodied as disklike of rectangular cross section (31).

13. The fuel injector of claim 11, wherein the deformable compensation element (30) is embodied as disklike of rectangular cross section (31).

14. The fuel injector of claim 10, further comprising a chamber (36) above a bearing face (18) of the nozzle lock nut (9) and surrounding the compensation element (30).

15. The fuel injector of claim 13, wherein the deformable compensation element (30) is embodied annularly of cylindrical cross section (38).

16. The fuel injector of claim 11, wherein the deformable compensation element (30) is embodied annularly of cylindrical cross section (38).

17. The fuel injector of claim 10, wherein the deformable compensation element (30) has a first face (32) having a first coefficient of friction (34) and a face (33) having a second coefficient of friction (35).

18. The fuel injector of claim 11, wherein the deformable compensation element (30) has a first face (32) having a first coefficient of friction (34) and a face (33) having a second coefficient of friction (35).

19. The fuel injector of claim 17, wherein the first coefficient of friction (34) of the compensation element (30) exceeds the second coefficient of friction (35).

20. The fuel injector of claim 18, wherein the first coefficient of friction (34) of the compensation element (30) exceeds the second coefficient of friction (35).

21. The fuel injector of claim 15, wherein the deformation of the deformable compensation element (30) is limited by the minimum chamber volume of the chamber (36).

22. The fuel injector of claim 11, wherein the deformation of the deformable compensation element (30) is limited by the minimum chamber volume of the chamber (36).

23. The first injector of claim 10, further comprising a valve insert part (41),
a shim (42) at a first butt joint (49) between the injector body (2) and the valve part (41), and
a second butt joint (15) between the valve part (41) and the shim (42), or a third butt joint (51) between the shim (42) and the nozzle body (6), with a deformable compensation element (30) being positioned between the components defining one or more of said butt joints.

24. The first injection of claim 11, further comprising
a valve insert part (41),
a shim (42) at a first butt joint (49) between the injector body (2) and the valve part (41), and
a second butt joint (15) between the valve part (41) and the shim (42), or a third butt joint (51) between the shim (42) and the nozzle body (6), with a deformable compensation element (30) being positioned between the components defining one or more of said butt joints.
